(19) United States
(12) Patent Application Publication
(10) Pub. No.: US 2022/0066347 A1
(43) Pub. Date: Mar. 3, 2022

(54) LIQUID ELECTROPHOTOGRAPHIC INK COMPOSITIONS

(71) Applicant: Hewlett-Packard Development Company, L.P., Spring, TX (US)

(72) Inventors: Hanit MAROM TCHAICHEEYAN, Nes Ziona (IL); Albert TEISHEV, Nes Ziona (IL); Doron GUROVICH, Nes Ziona (IL); Vladislav KAPLOUN, Nes Ziona (IL); Orel Yosef MIZRAHI, Nes Ziona (IL); Hodaya KEISAR, Nes Ziona (IL); Gilad NOY, Nes Ziona (IL); Adi Mann, Nes Ziona (IL)

(73) Assignee: Hewlett-Packard Development Company, L.P., Spring, TX (US)

(21) Appl. No.: 17/435,557

(22) PCT Filed: Oct. 11, 2019
(86) PCT No.: PCT/US2019/055826

§ 371 Date: Sep. 1, 2021

(51) Int. Cl. G03G 9/135; G03G 9/13; G03G 9/12

(52) U.S. Cl. CPC G03G 9/1355; G03G 9/122; G03G 9/131

(57) ABSTRACT

Described herein is a liquid electrophotographic ink composition comprising: a thermoplastic resin comprising a polymer having acidic side groups; a charge adjuvant comprising a complex of a metal(II) cation and two monovalent anions; or a complex of a metal(III) cation and three monovalent anions; or a complex of a metal(III) cation, a monovalent anion and a divalent anion, wherein each monovalent anion is independently selected from carboxylate anions having from 2 to 16 carbon atoms and alkoxide anions having from 1 to 16 carbon atoms; and wherein the divalent anion is selected form the oxo group, dicarboxylate anions having from 2 to 16 carbon atoms, and dialkoxide anions having from 1 to 16 carbon atoms; and a liquid carrier. Also described herein is a method of producing the liquid electrophotographic ink composition and a printed substrate.

Electrophotographic printing processes can involve creating an image on a photoconductive surface, applying an ink having charged particles to the photoconductive surface, such that they selectively bind to the image, and then transferring the charged particles in the form of the image to a substrate.

The photoconductive surface may be on a cylinder and may be termed a photo imaging plate (PIP). The photoconductive surface is selectively charged with a latent electrophotographic image having image and background areas with different potentials. For example, an electrophotographic ink composition comprising charged toner particles in a carrier liquid can be brought into contact with the selectively charged photoconductive surface. The charged toner particles adhere to the image areas of the latent image while the background areas remain clean. The image is then transferred to a substrate (e.g. paper or plastic film) directly or, more commonly, by being first transferred to an intermediate transfer member, which can be a soft swelling blanket, and then to the substrate.

### BRIEF DESCRIPTION OF THE FIGURES

FIG. 1 is a schematic illustration of an example of a liquid electrophotographic printer for printing a liquid electrophotographic ink composition.

FIG. 2 shows a graph comparing the particle conductivity variation of reference formulation no. 1 (0.8 wt. % VCA and 3 h grinding) compared to reference white ink formulation no. 2 (5 wt. % VCA and 1 h grinding) before and after a voltage scan (VS).

FIG. 3 shows a graph of the particle conductivity variation of reference formulation no. 3 (3 wt. % VCA and 1 h grinding) before and after a voltage scan (VS).

FIG. 4 shows a graph of the opacity of the background areas against the opacity of the image areas for reference formulation no. 4 (0.8 wt. % VCA and 1 h grinding) before and after aging on press (8K imp).

FIG. 5 shows the charging of the LEP ink of Formulation no. 6 (an Example ink composition) before and after a voltage scan.

FIG. 6 shows the charging, measured after the precipitation stage, for formulation no. 7 (an Example ink composition) before and after a voltage scan.

FIG. 7 shows a graph of the opacity of the background areas against the opacity of the image areas for an LEP ink composition based formulation no. 7 (an Example ink composition) and the standard white LEP ink composition (formulation no. 1).

FIG. 8 shows particle conductivity of ink compositions as a function of the amount of charge adjuvant M24 in the formulation.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “liquid carrier”, “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a liquid carrier. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a plastic film. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/μm, or more, in some examples, 600-900V/μm, or more.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a liquid electrophotographic ink composition. The liquid electrophotographic ink composition may comprise:
a thermoplastic resin comprising a polymer having acidic side groups;
a charge adjuvant comprising
   a complex of a metal(II) cation and two monovalent anions, or
   a complex of a metal(III) cation and three monovalent anions, or
   a complex of a metal(III) cation, a monovalent anion and a divalent anion;
   wherein each monovalent anion is independently selected from carbon/late anions having from 2 to 16 carbon atoms and alkoxide anions having from 1 to 16 carbon atoms; and
   wherein the divalent anion is selected from the oxo group, a dicarboxylate anion having from 2 to 16 carbon atoms and a dialkoxide anion having from 1 to 16 carbon atoms; and
a liquid carrier.

In another aspect, there is provided a method of producing a liquid electrophotographic ink composition. The method of producing a liquid electrophotographic ink composition may comprise:
dissolving a charge adjuvant in a dispersion of a thermoplastic resin in a liquid carrier;
wherein the thermoplastic resin comprises a polymer having acidic side groups; and
wherein the charge adjuvant comprises
   a complex of a metal(II) cation and two monovalent anions, or
   a complex of a metal(III) cation and three monovalent anions; or
   a complex of a metal(III) cation, a monovalent anion and a divalent anion;
   wherein each monovalent anion is independently selected from carboxylate anions having from 2 to 16 carbon atoms and alkoxide anions having from 1 to 16 carbon atoms; and
   wherein the divalent anion is selected from the oxo group, a dicarboxylate anion having from 2 to 16 carbon atoms and a dialkoxide having from 1 to 16 carbon atoms.

In a further aspect, there is provided a printed substrate. The printed substrate may comprise:
a substrate; and
a liquid electrophotographic ink composition disposed on the substrate;
wherein the liquid electrophotographic ink composition comprises:
   a thermoplastic resin comprising a polymer having acidic side groups; and
   a charge adjuvant comprising
      a complex of a metal(II) cation and two monovalent anions, or
      a complex of a metal(III) cation and three monovalent anions; or
      a complex of a metal(III) cation, a monovalent anion and a divalent anion;
      wherein each monovalent anion is independently selected from carboxylate anions having from 2 to 16 carbon atoms and alkoxide anions having from 1 to 16 carbon atoms; and
      wherein the divalent anion is selected from the oxo group, a dicarboxylate anion having from 2 to 16 carbon atoms and a dialkoxide anion having from 1 to 16 carbon atoms.

A charge adjuvant is added to liquid electrophotographic ink compositions to promote charging of the chargeable particles when a charge director is present. Currently, VCA is the charge adjuvant used in many liquid electrophotographic ink compositions. VCA is a mixture of aluminium mono-, di- and tri-stearates (linear C18 carboxylate), that is, a mixture of [Al(OH)₂(C₁₈H₃₅O₂)], [Al(OH)(C₁₈H₃₅O₂)₂] and [Al(C₁₈H₃₅O₂)₃]. This mixture is insoluble in the liquid carrier and requires the use of impact forces (e.g., from grinding of the ink) to react with the acidic groups of thermoplastic resins in the LEP ink compositions. Examples of the liquid electrophotographic ink compositions and methods described herein have been found to avoid or at least mitigate at least one of these difficulties. It has been found that the charge adjuvants disclosed herein can be used in LEP ink compositions that can be prepared with shorter grinding times and even without the need for grinding at all. Additionally, lower amounts of charge adjuvant have been found to be needed to achieve the same charging level as with VCA without altering the charging behaviour of the liquid electrophotographic ink compositions.

### Liquid Electrophotographic Ink Composition

A liquid electrophotographic (LEP) ink composition may comprise a thermoplastic resin comprising a polymer having acidic side groups; a charge adjuvant comprising a complex of a metal(II) cation and two monovalent anions; or a complex of a metal(III) cation and three monovalent anions; or a complex of a metal(III) cation, a monovalent anion and a divalent anion, wherein each monovalent anion is independently selected from carboxylate anions having from 2 to 10 carbon atoms and alkoxide anions having from 1 to 10 carbon atoms and wherein the divalent anion is selected form the oxo group, a dicarboxylate anion having form 2 to 16 carbon atoms and a dialkoxide anion having form 1 to 16 carbon atoms; and a liquid carrier.

In some examples, the LEP ink composition may further comprise a colorant. In some examples, the liquid electrophotographic ink composition may comprise chargeable particles. The chargeable particles may comprise a thermoplastic resin and a colorant. In some examples, the LEP ink composition may comprise a thermoplastic resin, a charge adjuvant, a liquid carrier and a colorant.

In some examples, the LEP ink composition may further comprise a charge director. In some examples, the LEP ink composition may comprise a thermoplastic resin, a charge adjuvant, a liquid carrier and a charge director. In some examples, the LEP ink composition may comprise a thermoplastic resin, a charge adjuvant, a liquid carrier, a colorant and a charge director.

In some examples, the LEP ink composition may further comprise other additives or a plurality of other additives.

### Charge Adjuvant

The LEP ink composition may comprise a charge adjuvant. The charge adjuvant may comprise a complex of a metal(II) cation and two monovalent anions; or a complex of a metal(III) cation and three monovalent anions; or a complex of a metal(III) cation, a monovalent anion and a divalent anion. In some examples, each monovalent anion may be independently selected form carboxylate anions having 1 to 16 carbon atoms and alkoxide anions having from 1 to 16 carbon atoms. In some examples, the divalent anion may be selected from the oxo group, a dicarboxylate anion having 2 to 16 carbon atoms and a dialkoxide anion having from 1 to 16 carbon atoms.

In some examples, the charge adjuvant may comprise a complex of Al³⁺ and three monovalent anions, wherein each monovalent anion is independently selected from carboxylate anions having from 2 to 16 carbon atoms and alkoxide anions having from 1 to 16 carbon atoms.

In some examples, the charge adjuvant may comprise a complex of Al³⁺ and three monovalent anions, wherein each monovalent anion is independently selected from carboxylate anions having from 2 to 10 carbon atoms and alkoxide anions having from 1 to 10 carbon atoms.

As used herein, a carboxylate anion is the conjugate base of a carboxylic acid. As used herein, an alkoxide anion is the conjugate base of an alcohol. As used herein, an oxo group is an ═O group, that is, a complex containing an oxo group contains an oxygen atom bound to the metal by a double bond. As used herein, a dicarboxylate contains two carboxylate anions. As used herein, a dialkoxide contains two alkoxide anions.

In some examples, the charge adjuvant comprises a complex of a metal(II) cation and two monovalent anions. In some examples, the metal(II) cation may be selected from COO, and Mg(II).

In some examples, the charge adjuvant comprises a complex of a metal(III) cation and three monovalent anions or a complex of a metal(III) cation, a monovalent anion and a divalent anion. In some examples, the charge adjuvant comprises a complex of a metal(III) and three monovalent anions. In some examples, the metal(III) cation may be selected from Al(III), Cr(III) and Mn(III). In some examples, the metal(III) cation is Al³⁺.

In some examples, the three monovalent anions may be the same or different. In some examples, the three monovalent anions are the same. In some examples, the charge adjuvant comprises two different monovalent anions.

In some examples, each monovalent anion is independently selected from carboxylate anions having from 2 to 16 carbon atoms and alkoxide anions having from 1 to 16 carbon atoms. In some examples, the carboxylate anions may have from 2 to 10 carbon atoms, for example, from 3 to 9 carbon atoms, from 4 to 8 carbon atoms, from 5 to 10 carbon atoms, from 6 to 9 carbon atoms, from 7 to 8 carbon atoms. In some examples, the alkoxide anions may have from 1 to 10 carbon atoms, for example, from 2 to 9 carbon atoms, from 3 to 8 carbon atoms, from 3 to 7 carbon atoms, from 1 to 6 carbon atoms, from 2 to 5 carbon atoms, 4 to 6 carbon atoms.

In some examples, the divalent anion may is selected from the oxo group, dicarboxylate anions having from 2 to 16 carbon atoms and dialkoxide anions having from 1 to 16 carbon atoms. In some examples, the dicarboxylate anions may have from 2 to 10 carbon atoms, for example, from 3 to 9 carbon atoms, from 4 to 8 carbon atoms, from 5 to 10 carbon atoms, from 6 to 9 carbon atoms, from 7 to 8 carbon atoms. In some examples, the dialkoxide anions may have from 1 to 10 carbon atoms, for example, from 2 to 9 carbon atoms, from 3 to 8 carbon atoms, from 3 to 7 carbon atoms, from 1 to 6 carbon atoms, from 2 to 5 carbon atoms, 4 to 6 carbon atoms. In some examples, the divalent anion may be the oxo group.

In some examples, the carboxylate anions may be substituted or unsubstituted linear carboxylate anions, substituted or unsubstituted branched chain carboxylate anions or substituted or unsubstituted cyclic carboxylate anions. In some examples, the carboxylate anions may be selected from substituted or unsubstituted branched chain carboxylates. In some examples, the dicarboxylate anions may be substituted or unsubstituted linear dicarboxylate anions, substituted or unsubstituted branched chain dicarboxylate anions or substituted or unsubstituted cyclic dicarboxylate anions. In some examples, the dicarboxylate anions may be selected from substituted or unsubstituted branched chain dicarboxylates.

In some examples, the alkoxide anions may be substituted or unsubstituted linear alkoxides, substituted or unsubstituted branched chain alkoxides or substituted or unsubstituted cyclic alkoxides. In some examples, the alkoxide anions may be selected from substituted or unsubstituted branched chain alkoxides. In some examples, the dialkoxide anions may be substituted or unsubstituted linear dialkoxides, substituted or unsubstituted branched chain dialkoxides or substituted or unsubstituted cyclic dialkoxides. In some examples, the alkoxide anions may be selected from substituted or unsubstituted branched chain dialkoxides.

In some examples, the alkoxide anion may be an alkoxide ester, for example, an acetoacetic ester.

In some examples, each monovalent anion may be independently selected from ethanoate, propanoate, butanoate, pentanoate, hexanoate, heptanoate, octanoate, nonanoate, decanoate, 2-methylpropanoate, 2-methylbutanoate, 3-methylbutanoate, 2-ethylbutanoate, 2-methylpentanoate, 3-methylpentanoate, 4-methylpentanoate, 2-ethyl-pentanoate, 3-ethylpentanoate, 2-propylpentanoate, 2-methylhexanoate, 3-methyl-hexanoate, 4-methylhexanoate, 5-methylhexanoate, 2-ethylhexanoate, 3-ethyl-hexanoate, 4-ethylhexanoate, 3-propylhexanoate, 2-butylhexanoate, 2-methyl-heptanoate, 3-methylheptanoate, 4-methylheptanoate, 5-methylheptanoate, 6-methyl-heptanoate, 2-ethylheptanoate, 3-ethylheptanoate, 4-ethylheptanoate, 5-ethyl-heptanoate, 2-propylheptanoate, 3-propylheptanoate, 4-propylheptanoate, 2-methyl-octanoate, 3-methyloctanoate, 4-methyloctanoate, 5-methyloctanoate, 6-methyl-octanoate, 7-methyloctanoate, 2-ethyloctanoate, 3-ethyloctanoate, 4-ethyloctanoate, 5-ethyloctanoate, 6-ethyloctanoate, 2-methylnonanoate, 3-methylnonanoate, 4-methyl-nonanoate, 5-methylnonanoate, 6-methylnonanoate, 7-methylnonanoate, 8-methyl-nonanoate, methoxide, ethoxide, propanolate, butanolate, pentanolate, hexanolate, heptanolate, octanolate, nonanolate, decanolate, 2-methylpropanolate, 2-methyl-butanolate, 3-methylbutanoate, 2-ethylbutanolate, 2-methylpentanolate, 3-methyl-pentanolate, 4-methylpentanolate, 2-ethylpentanolate, 3-ethylpentanolate, 2-propyl-pentanolate, 2-methylhexanolate, 3-methylhexanolate, 4-methylhexanolate, 5-methyl-hexanolate, 2-ethylhexanolate, 3-ethylhexanolate, 4-ethylhexanolate, 3-propyl-hexanolate, 3-propylhexanolate, 2-butylhexanolate, 2-methylheptanoate, 3-methyl-heptanolate, 4-methylheptanolate, 5-methylheptanolate, 6-methylheptanolate, 2-ethyl-heptanolate, 3-ethylheptanolate, 4-ethylheptanolate, 5-ethylheptanolate, 2-propyl-heptanolate, 3-propylheptanolate, 4-propylheptanolate, 2-methyloctanolate, 3-methyl-octanolate, 4-methyloctanolate, 5-methyloctanolate, 6-methyloctanolate, 7-methyl-octanolate, 2-ethyloctanolate, 3-ethyloctanolate, 4-ethyloctanolate, 5-ethyloctanolate, 6-ethyloctanolate, 2-methylnonanolate, 3-methylnonanolate, 4-methylnonanolate, 5-methylnonanolate, 6-methylnonanolate, 7-methylnonanolate, 8-methylnonanolate, acetoacetic methyl ester, acetoacetic ethyl ester, acetoacetic propyl ester, acetoacetic isopropyl ester, acetoacetic pentyl ester, acetoacetic hexyl ester and combinations thereof.

In some examples, the divalent anion may be selected from an oxo group, methanedioate, methanediolate, ethanedioate, ethanediolate, propanedioate, propanediolate, butanedioate, butanediolate, pentanedioate, pentanediolate, hexanedioate, hexanediolate, heptanedioate, heptanediolate, octanedioate, octanediolate, nonanedioate, nonanediolate, decanedioate and decanediolate. In some examples, the divalent anion may be an oxo group and the monovalent anion may be any one of the monovalent anions listed above.

In some examples, the each monovalent anion may be independently selected from octanoate, methylheptanoate, ethylhexanoate, propylpentanoate, propoxide, isopropoxide, acetoacetic methyl ester, acetoacetic ethyl ester, acetoacetic propyl ester, acetoacetic isopropyl ester and combinations thereof; and the divalent anion may be the oxo group.

In some examples, each monovalent anion may be independently selected from octanoate, methylheptanoate, ethylhexanoate, propylpentanoate, propoxide, isopropoxide, acetoacetic methyl ester, acetoacetic ethyl ester, acetoacetic propyl ester, acetoacetic isopropyl ester, and combinations thereof. In some examples, each monovalent anion may be independently selected from branched C8 carboxylate anions, branched C3 alkoxide anions and acetoacetic esters. In some examples, the three monovalent anions may be a branched C8 carboxylate anions, for example, 2-ethylhexanoate.

In some examples, the charge adjuvant is selected from aluminium trioctanoate, aluminium trimethylheptanoate, aluminium triethylhexanoate, aluminium tripropyl-pentanoate, aluminium tripropoxide, aluminium triisopropoxide, aluminium di-(isopropoxide)acetoacetic ester chelate, oxoaluminium acylate, oxoaluminium benzoate, and oxo(propan-2-olato)aluminium. In some examples, the charge adjuvant is selected from aluminium tri-2-ethylhexanoate, aluminium triisopropoxide and aluminium di(isopropoxide)acetoacetic ester chelate. In some examples, the aluminium di(isopropoxide)acetoacetic ester chelate may be aluminium di(isopropoxide)-acetoacetic ethyl ester or aluminium di(isopropoxide)acetoacetic isopropyl ester.

In some examples, the charge adjuvant is present in the liquid electrophotographic ink composition in an amount of up to about 2 wt. % of the total solids of the LEP ink composition, for example, up to about 1.5 wt. %, up to about 1 wt. %, up to about 0.9 wt. %, up to about 0.8 wt. %, up to about 0.75 wt. %, up to about 0.7 wt. %, up to about 0.6 wt. %, up to about 0.5 wt. %, up to about 0.4 wt. %, up to about 0.3 wt. %, up to about 0.2 wt. %, up to about 0.1 wt. %, up to about 0.09 wt. %, up to about 0.08 wt. %, up to about 0.07 wt. %, up to about 0.06 wt. %, up to about 0.05 wt. %, up to about 0.04 wt. %, up to about 0.03 wt. %, up to about 0.02 wt. %, or up to about 0.01 wt. % of the total solids of the LEP ink composition. In some examples, the charge adjuvant is present in the liquid electrophotographic ink composition in an amount of about 0.01 wt. % or more of the total solids of the LEP ink composition, for example, about 0.02 wt. % or more, about 0.03 wt. % or more, about 0.04 wt. % or more, about 0.05 wt. % or more, about 0.06 wt. % or more, about 0.07 wt. % or more, about 0.08 wt. % or more, about 0.09 wt. % or more, about 0.1 wt. % or more, about 0.2 wt. % or more, about 0.3 wt. % or more, about 0.4 wt. % or more, about 0.5 wt. % or more, about 0.6 wt. % or more, about 0.7 wt. % or more, about 0.8 wt. % or more, about 0.9 wt. % or more, about 1 wt. % or more, about 1.5 wt. % or more, or about 2 wt. % or more of the total solids of the LEP ink composition. In some examples, the charge adjuvant is present in the liquid electrophotographic ink composition in an amount of from about 0.01 wt. % to about 2 wt. % of the total solids of the LEP ink composition, for example, about 0.02 wt. % to about 2 wt. %, about 0.03 wt. % to about 1.5 wt. %, about 0.04 wt. % to about 1 wt. %, about 0.05 wt. % to about 0.9 wt. %, about 0.06 wt. % to about 0.8 wt. %, about 0.07 wt. % to about 0.7 wt. %, about 0.08 wt. % to about 0.6 wt. %, about 0.09 wt. % to about 0.5 wt. %, about 0.1 wt. % to about 0.4 wt. %, or about 0.2 wt. % to about 0.3 wt. % of the total solids of the LEP ink composition.

### Thermoplastic Resin

The liquid electrophotographic ink composition comprises a thermoplastic resin. In some examples, the thermoplastic resin comprises a polymer having acidic side groups. The thermoplastic resin may be referred to herein as a resin.

In some examples, the LEP ink composition comprises chargeable particles (i.e., having or capable of developing a charge, for example, in an electromagnetic field) including the thermoplastic resin and, in some examples, a colorant.

In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers:ethylene-acrylic esters-maleic anhydride (MAH) or glycidyl methacrylate (GMA) terpolymers; ethylene-acrylic acid ionomers and combinations thereof.

The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt. %, in some examples about 11 wt. %) having a melt flow rate of 80 to 110 g/10 minutes and a second polymer that is a copolymer of ethylene (e.g. about 80 to 92 wt. %, in some examples about 85 wt. %) and acrylic acid (e.g. about 18 to 12 wt. %, in some examples about 15 wt. %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers.

The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the copolymer, in some examples 10 wt. % to 16 wt. % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the copolymer, in some examples from 14 wt. % to about 20 wt. % of the copolymer, in some examples from 16 wt. % to about 20 wt. % of the copolymer in some examples from 17 wt. % to 19 wt. % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the LEP ink composition, in some examples 50% to 90% by weight of the total solids of the LEP ink composition, in some examples 65% to 80% by weight of the total solids of the LEP ink composition. In some examples, the LEP ink composition may comprise resin in an amount of from 10% to 50% by weight of the total solids, for example, 15 to 45% by weight, 20% to 40% by weight, 25% to 35% by weight of the total solids.

### Liquid Carrier

The LEP ink composition comprises, before printing, a liquid carrier.

In some examples, when printing, the LEP ink composition comprises a liquid carrier. Generally, the liquid carrier can act as a dispersing medium for the other components in the LEP ink composition. For example, the liquid carrier can comprise or be a hydrocarbon, silicone oil, vegetable oil, and so forth. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the liquid carriers include, but are not limited to, aliphatic hydrocarbons, isoparaffinic compounds, paraffinic compounds, dearomatized hydrocarbon compounds, and the like. In some examples, the hydrocarbon may be one or more isoparaffins having 5 to 15 carbon atoms, for example, 10 to 14 carbon atoms, 11 to 13 carbon atoms. In particular, the liquid carriers can include, but are not limited to, Isopar-G™, Isopar-H, Isopar-L™, Isopar-M, Isopar-K™, Isopar-V™, Norpar 12™, Norpar 13™, Norpar 15™, Exxol D40 ™ Exxol D80 ™ Exxol D100™ Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400 AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before liquid electrophotographic printing, the liquid carrier can constitute about 20% to 99.5% by weight of the liquid electrostatic ink composition, in some examples 50% to 99.5% by weight of the liquid electrostatic ink composition. Before printing, the liquid carrier may constitute about 40% to 90% by weight of the liquid electrostatic ink composition. Before printing, the liquid carrier may constitute about 60% to 80% by weight of the liquid electrostatic ink composition. Before printing, the liquid carrier may constitute about 90% to 99.5% by weight of the liquid electrostatic ink composition, in some examples 95% to 99% by weight of the liquid electrostatic ink composition.

The liquid electrostatic ink composition, once electrostatically printed on the substrate, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that liquid electrostatically printed ink contains less than 5 wt. % liquid carrier, in some examples, less than 2 wt. % liquid carrier, in some examples less than 1 wt. % liquid carrier, in some examples less than 0.5 wt. % liquid carrier. In some examples, liquid electrostatically printed ink is free from liquid carrier.

### Colorant

The liquid electrophotographic ink composition may include a colorant. In some examples, the colorant may be a dye or pigment.

As used herein, “colorant” may be a material that imparts a colour to the ink composition. As used herein, “colorant” includes pigments and dyes, such as those that impart colours, such as black, magenta, cyan, yellow and white, to an ink. As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth.

In some examples, the colorant is selected from cyan colorants, magenta colorants, yellow colorants, black colorants, white colorants and silver colorants. In some examples, the colorant is selected from cyan pigments, magenta pigments, yellow pigments, black pigments, white pigments and silver pigments. In some examples, the colorant may be a white pigment or a silver pigment. In some examples, the colorant may be a white pigment.

The colorant can be any colorant compatible with the carrier liquid and useful for liquid electrophotographic printing. For example, the colorant may be present as pigment particles, or may comprise a resin as described herein and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment. If the pigment is a silver pigment, the pigment may be an aluminium powder.

### Charge Director

In some examples, the LEP ink composition further includes a charge director. The charge director may be added in order to impart and/or maintain sufficient electrostatic charge on the ink particles, which may be particles comprising the thermoplastic resin. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a yellow LEP ink composition.

In some examples, the liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO₃⁻, NO₃⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the liquid electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃⁻)—C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount sufficient to achieve a particle conductivity of 500 pmho/cm or less, in some examples, 450 pmho/cm or less, in some examples, 400 pmho/cm or less, in some examples, 350 pmho/cm or less, in some examples, 300 pmho/cm or less, in some examples, 250 pmho/cm or less, in some examples, 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm, in some examples, 150 pmho/cm or more, in some examples, 200 pmho/cm or more, in some examples, 250 pmho/cm or more, in some examples, 300 pmho/cm or more, in some examples, 350 pmho/cm or more, in some examples, 400 pmho/cm or more, in some examples, 450 pmho/cm or more, in some examples, 500 pmho/cm or more. In some examples, the charge director is present in an amount sufficient to achieve a particle conductivity of 50 pmho/cm to 500 pmho/cm, in some examples, 60 pmho/cm to 450 pmho/cm, in some examples, 70 pmho/cm to 400 pmho/cm, in some examples, 80 pmho/cm to 350 pmho/cm, in some examples, 90 pmho/cm to 300 pmho/cm, in some examples, 100 pmho/cm to 250 pmho/cm, in some examples, 110 pmho/cm to 200 pmho/cm, in some examples, 120 pmho/cm to 500 pmho/cm, in some examples, 130 pmho/cm to 450 pmho/cm, in some examples, 140 pmho/cm to 400 pmho/cm, in some examples, 150 pmho/cm to 350 pmho/cm, in some examples, 160 pmho/cm to 300 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

### Method of Producing a Liquid Electrophotographic Ink Composition

Described herein is a method of producing a liquid electrophotographic ink composition. In some examples, the method of producing a liquid electrophotographic ink composition may comprise dissolving a charge adjuvant in a dispersion of a thermoplastic resin in a liquid carrier.

In some examples, the method of producing a liquid electrophotographic ink composition may comprise dissolving a charge adjuvant in a dispersion of a thermoplastic resin in a liquid carrier; wherein the thermoplastic resin comprises a polymer having acidic side groups; and wherein the charge adjuvant comprises a complex of a metal(II) cation and two monovalent anions; or a complex of a metal(III) cation (e.g., Al³⁺) and three monovalent anions or a complex of a metal(III) cation (e.g., Al³⁺), a divalent anion and a monovalent anion, wherein each monovalent anion is independently selected from carboxylate anions having from 2 to 16 carbon atoms (e.g., 2 to 10 carbon atoms) and alkoxide anions having from 1 to 16 carbon atoms (e.g., 1 to 10 carbon atoms) and the divalent anion is selected from the oxo group, dicarboxylate anions having from 2 to 16 carbon atoms (e.g., 2 to 10 carbon atoms) and dialkoxide anions having from 1 to 16 carbon atoms (e.g., 1 to 10 carbon atoms). In some examples, the thermoplastic resin and the charge adjuvant may be as described herein.

In some examples, the dispersion of a thermoplastic resin in a liquid carrier further comprises a colorant. In some examples, the dispersion comprises chargeable particles dispersed in a liquid carrier. In some examples, the chargeable particles comprise a thermoplastic resin and a colorant.

In some examples, dissolving the charge adjuvant in the dispersion comprises combining the charge adjuvant with the dispersion and mixing. In some examples, the mixing is high shear mixing. In some examples, mixing is at a mixing rate of at least about 50 rpm, for example, at least about 60 rpm, at least about 70 rpm, at least about 80 rpm, at least about 90 rpm, at least about 100 rpm, at least about 150 rpm. In some examples, mixing is at a mixing rate of about 150 rpm or less, for example, about 100 rpm or less, about 90 rpm or less, about 80 rpm or less, about 70 rpm or less, about 60 rpm or less, about 50 rpm or less. In some examples, mixing is at a mixing rate of about 50 rpm to about 150 rpm, about 60 rpm to about 100 rpm, or about 70 rpm to about 80 rpm. In some examples, a rotor stator operated in addition to the mixing. In some examples, the rotor stator was rotated at a rate of at least about 400 rpm, for example, at least about 500 rpm, at least about 600 rpm, at least about 700 rpm, at least about 800 rpm, at least about 900 rpm, at least about 1000 rpm, at least about 1100 rpm, at least about 1200 rpm, at least about 1300 rpm, at least about 1400 rpm, at least about 1500 rpm, at least about 1600 rpm, at least about 1700 rpm, at least about 1800 rpm, at least about 1900 rpm, at least about 2000 rpm, at least about 2100 rpm, at least about 2200 rpm, at least about 2300 rpm, at least about 2400 rpm, or at least about 2500 rpm. In some examples, the rotor stator was rotated at a rate of about 2500 rpm or less, for example, about 2400 rpm or less, about 2300 rpm or less, about 2200 rpm or less, about 2100 rpm or less, about 2000 rpm or less, about 1900 rpm or less, about 1800 rpm or less, about 1700 rpm or less, about 1600 rpm or less, about 1500 rpm or less, about 1400 rpm or less, about 1300 rpm or less, about 1200 rpm or less, about 1100 rpm or less, about 1000 rpm or less, about 900 rpm or less, about 800 rpm or less, about 700 rpm or less, about 600 rpm or less, about 500 rpm or less, or about 400 rpm or less. In some examples, the rotor stator was rotated at a rate of .about 400 rpm to about 2500 rpm, about 500 rpm to about 2400 rpm, about 600 rpm to about 2300 rpm, about 700 rpm to about 2200 rpm, about 800 rpm to about 2100 rpm, about 900 rpm to about 2000 rpm, about 1000 rpm to about 1900 rpm, about 1100 rpm to about 1800 rpm, about 1200 rpm to about 1700 rpm, about 1300 rpm to about 1600 rpm, or about 1400 rpm to about 1500 rpm.

In some examples, the charge adjuvant is dissolved in the dispersion at a temperature of about 100° C. or less, for example, about 95° C. or less, about 90° C. or less, about 85° C. or less, about 80° C. or less, about 75° C. or less, about 70° C. or less, about 65° C. or less, about 60° C. or less, about 55° C. or less, about 50° C. or less, about 45° C. or less, about 40° C. or less, about 35° C. or less, about 30° C. or less, about 25° C. or less, or about 20° C. or less. In some examples, the charge adjuvant is dissolved in the dispersion at a temperature of about 20° C. or more, for example, about 25° C. or more, about 30° C. or more, about 35° C. or more, about 40° C. or more, about 45° C. or more, about 50° C. or more, about 55° C. or more, about 60° C. or more, about 65° C. or more, about 70° C. or more, about 75° C. or more, about 80° C. or more, about 85° C. or more, about 90° C. or more, about 95° C. or more, or about 100° C. or more. In some examples, the charge adjuvant is dissolved in the dispersion at a temperature of from about 20° C. to about 100° C., for example, about 25° C. to about 95° C., about 30° C. to about 90° C., about 35° C. to about 85° C., about 40° C. to about 80° C., about 45° C. to about 75° C., about 50° C. to about 70° C., about 55° C. to about 65° C., or about 60° C. to about 65° C.

In some examples, dissolving the charge adjuvant in the dispersion comprises combining the charge adjuvant with the dispersion and grinding the composition. In some examples, grinding is performed for 2 h or less, for example, 1.5 h or less, 1 h or less. In some examples, grinding is performed for 30 min to 2 h, for example, 40 min to 1.5 h, or 50 min to 1 h. In some examples, grinding is at a grinding speed of at least 500 rpm, for example, at least 600 rpm, at least 700 rpm, at least 800 rpm, at least 900 rpm, or 1000 rpm. In some examples, grinding is at a grinding speed of 1500 rpm or less, for examples, 1400 rpm or less, 1300 rpm or less, 1200 rpm or less or 1100 rpm. In some examples, dissolving the charge adjuvant in the dispersion does not involve grinding the composition. In some examples, the method of producing a liquid electrophotographic ink composition does not involve grinding the composition.

In some examples, the dissolved charge adjuvant reacts with the acid groups of the thermoplastic resins, forming resin-charge adjuvant complexes containing —C(O)O-metal(anion) groups, or —C(O)O-metal(anion)₂ (e.g., —C(O)O—Al(anion)₂) groups or —C(O)O-metal=O groups (e.g., —C(O)—Al═O) and a free carboxylic acid or alcohol molecule.

In some examples, the method of producing a liquid electrophotographic ink composition comprises forming the dispersion of a thermoplastic resin in a liquid carrier and then dissolving the charge adjuvant in the dispersion. In some examples, the dispersion of the thermoplastic resin in a liquid carrier is formed by precipitating the thermoplastic resin in the liquid carrier. In some examples, the dispersion of the thermoplastic resin in a liquid carrier is formed by grinding the thermoplastic resin in the liquid carrier.

In some examples, the dispersion of the thermoplastic resin in a liquid carrier comprises a dispersion of chargeable particles in a liquid carrier. In some examples, the chargeable particles comprise the thermoplastic resin. In some examples, the chargeable particles comprise the thermoplastic resin and a colorant.

In some examples, the dispersion of chargeable particles in a liquid carrier is formed by grinding the thermoplastic resin and the colorant in the liquid carrier to form chargeable particles comprising the thermoplastic resin and the colorant dispersed in the liquid carrier.

In some examples, the dispersion of chargeable particles in a liquid carrier is formed by precipitating the thermoplastic resin in the liquid carrier in the presence of the colorant to form chargeable particles dispersed in the liquid carrier, the chargeable particles comprising the thermoplastic resin and the colorant.

In some examples, the dispersion is formed by combining the thermoplastic resin and optionally the colorant with the liquid carrier. In some examples, the thermoplastic resin and the liquid carrier are combined and heated to an elevated temperature. In some examples, the thermoplastic resin, the colorant and the liquid carrier are combined and heated to an elevated temperature. In some examples, the thermoplastic resin and the liquid carrier are combined and heated to an elevated temperature before adding the colorant, which may also have been heated to an elevated temperature. The elevated temperature may be above the melting point of the thermoplastic resin. In some examples, the elevated temperature is a temperature at which the thermoplastic resin is dissolved in the carrier liquid. In some examples, the elevated temperature is a temperature of at least 70° C., for example, at least 80° C., for example, at least 90° C., for example, at least 100° C., for example, at least 110° C., for example, at least 120° C., for example, 130° C., for example, to melt the thermoplastic resin. The melting point of the resin may be determined by differential scanning calorimetry, for example, using ASTM D3418. Melting and/or dissolving a thermoplastic resin (or resins) in the carrier liquid may result in the carrier fluid appearing clear and homogeneous. Melting and/or dissolving a resin (or resins) in the carrier liquid may result in the carrier fluid appearing clear and homogeneous. In some examples, the resin (or resins) and carrier liquid are heated before, during or after the colorant is added.

In some examples, the thermoplastic resin (or resins) and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin (or resins) in the carrier liquid is complete.

In some examples, after combining and heating the resins and the carrier liquid, the mixture is cooled to a temperature below the melting point of the resins, for example, to room temperature. In some examples, the precipitation of the thermoplastic resin on cooling forms the chargeable particles comprising the thermoplastic resin and the colorant. In some examples, the chargeable particles are removed from the carrier liquid and re-dispersed in a new portion of carrier liquid, which may be the same or a different carrier liquid.

In some examples, after the charge adjuvant is dissolved in the dispersion, a charge director is added. In some examples, the charge director is mixed with the dispersion comprising the dissolved charge adjuvant. In some examples, the charge director is added immediately before the liquid electrophotographic ink composition is printed.

### Printed Substrate

Also described herein is a printed substrate comprising a substrate; and a liquid electrophotographic ink composition disposed on the substrate. In some examples, the printed substrate comprises a substrate; and a liquid electrophotographic ink composition disposed on the substrate; wherein the liquid electrophotographic ink composition comprises: a thermoplastic resin comprising a polymer having acidic side groups; and a charge adjuvant comprising a complex of a metal(II) cation and two monovalent anions; or a complex of a metal(III) cation, for example, Al³⁺, and three monovalent anions; or a complex of a metal(III) cation, for example, Al³⁺, a divalent anion and a monovalent anion, wherein each monovalent anion is independently selected from carboxylate anions having from 2 to 16 carbon atoms and alkoxide anions having from 1 to 16 carbon atoms; and wherein the divalent anion is selected from the oxo group, dicarboxylate anions having from 2 to 16 carbon atoms and dialkoxide anions having from 1 to 16 carbon atoms.

In some examples, the printed substrate may further comprise a primer disposed between the substrate and the liquid electrophotographic ink composition.

### Substrate

In some examples, the substrate may be any suitable substrate. In some examples, the substrate may be any suitable substrate capable of having an image printed thereon. The substrate may include a material selected from an organic or inorganic material. The material may include a natural polymeric material, for example, cellulose. The material may include a synthetic polymeric material, for example, a polymer formed from alkylene monomers, including, but not limited to, polyethylene, polypropylene, and co-polymers such as styrene-polybutadiene. The polypropylene may, in some examples, be biaxially oriented polypropylene. The material may include a metal, which may be in sheet form. The metal may be selected from or made from, for instance, aluminium (Al), silver (Ag), tin (Sn), copper (Cu) and mixtures thereof. In an example, the substrate includes a cellulosic paper. In an example, the cellulosic paper is coated with a polymeric material, for example, a polymer formed from styrene-butadiene resin. In some examples, the cellulosic material has an inorganic material bound to its surface (before printing with ink) with a polymeric material, wherein the inorganic material may be selected from, for example, kaolinite or calcium carbonate. In some examples, the substrate is a cellulosic substrate such as paper. In some examples, the cellulosic substrate may be a coated cellulosic substrate. In some examples, a primer may be coated onto the substrate before the electrophotographic ink composition is printed onto the substrate.

In some examples, the substrate may be a plastic film. In some examples, the substrate may be any plastic film capable of having an image printed thereon. The plastic film may include a synthetic polymeric material, for example, a polymer formed from alkylene monomers, including, for example, polyethylene and polypropylene, and co-polymers such as styrene-polybutadiene polymers. The polypropylene may, in some examples, be biaxially orientated polypropylene. In some examples, the plastic film may comprise polyethylene terephthalate.

In some examples, the plastic film is a thin film. In some examples, the plastic film comprises polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA), or polyethylene terephthalate (PET).

In some examples, the substrate comprises a plurality of layers of material laminated together to form a pre-laminated substrate. In some examples, the substrate comprises a plurality of layers of material laminated together to form a pre-laminated substrate in which a plastic film forms the surface onto which electrophotographic ink can be applied. In some examples, the substrate comprises a plurality of layers of film laminated together to form a pre-laminated substrate in which a plastic film forms the surface onto which liquid electrophotographic ink can be applied. In an example, the substrate may be a plastic film laminated to, adhered to or coated on a cellulosic paper. In some examples, the substrate comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as met-PET, met-BOPP or any other metalized substrate), paper and combinations thereof. In some examples, the substrate comprises a plurality of layers of film of a plastic material, such as a combination of films selected from PE, LLDPE, MDPE, PP, BOPP, PET and OPA, laminated together to form the pre-laminated substrate. In some examples, the pre-laminated substrate comprises a Paper/Alu/PE, PET/Al/PE, BOPP/met-BOPP or PET/PE laminate.

In some examples, the substrate comprises a thin material, wherein the material has a thickness of 600 μm or less, for example, 250 μm or less, for example, 200 μm or less, for example, 150 μm or less, for example, 100 μm or less, for example, 90 μm or less, for example, 80 μm or less, for example, 70 μm or less, for example, 60 μm or less, for example, 50 μm or less, for example, 40 μm or less, for example, 30 μm or less, for example, 20 μm or less, for example, 15 μm or less. In some examples, the material is about 12 μm in thickness.

In some examples, the substrate comprises a thin material, wherein the material has a thickness of 12 μm or more, for example, 15 μm or more, for example, 20 μm or more, for example, 30 μm or more, for example, 40 μm or more, for example, 50 μm or more, for example, 60 μm or more, for example, 70 μm or more, for example, 80 μm or more, for example, 90 μm or more. In some examples, the material has a thickness of about 100 μm or more, in some examples, about 100 μm or more.

In some examples, the substrate comprises a thin material, wherein the material is from 12 μm to 600 μm in thickness, in some examples, from 15 μm to 250 μm in thickness, in some examples, from 20 μm to 200 μm in thickness, in some examples, from 30 μm to 150 μm in thickness, in some examples, 40 μm to 100 μm in thickness, in some examples, 50 μm to 150 μm, in some examples, 60 μm to 100 μm in thickness, in some examples, 70 to 90 μm in thickness.

### Method of Producing a Printed Substrate

Also described herein is a method of producing a printed substrate. In some examples, the method of producing a printed substrate comprises applying a liquid electrophotographic ink composition to a substrate with an electrophotographic printer.

In some examples, applying a liquid electrophotographic ink composition to a substrate with an electrophotographic printer comprises contacting the liquid electrophotographic ink composition with a latent electrophotographic image on a surface to create a developed image and transferring the developed image to the substrate.

In some examples, applying a liquid electrophotographic ink composition to a substrate with an electrophotographic printer comprises contacting the liquid electrophotographic ink composition with a latent electrophotographic image on a surface to create a developed image and transferring the developed image to an intermediate transfer member and then transferring the developed image from the intermediate transfer member to the substrate.

FIG. 1 shows a schematic illustration of a liquid electrophotographic (LEP) printer which may be used to print a liquid electrophotographic ink composition as described herein. An image, including any combination of graphics, text and images, may be communicated to the LEP printer 1. According to an illustrative example, in order to print the electrophotographic ink composition, firstly, the photo charging unit 2 deposits a uniform static charge on the photo-imaging cylinder 4 and then a laser imaging portion 3 of the photo-charging unit 2 dissipates the static charges in selected portions of the image areas on the photo-imaging cylinder 4 to leave a latent electrophotographic image. The latent electrophotographic image, also called a latent electrostatic image, is an electrostatic charge pattern representing the image to be printed. The electrophotographic ink composition is then transferred to the photo-imaging cylinder 4 by binary ink developer (BID) units 6. The BID units 6 present a uniform film of the electrophotographic ink composition to the photo-imaging cylinder 4. A resin component of the electrophotographic ink composition may be electrically charged by virtue of an appropriate potential applied to the electrophotographic ink composition in the BID unit 6. The charged resin component is, by virtue of an appropriate potential on the electrostatic image areas, attracted to the latent electrostatic image on the photo-imaging cylinder 4. The electrophotographic ink composition does not adhere to the uncharged, non-image areas and forms an image on the surface of the latent electrostatic image. The photo-imaging cylinder 4 then has a developed electrostatic ink composition on its surface.

The image is then transferred from the photo-imaging cylinder 4 to the intermediate transfer member (ITM) 8 by virtue of an appropriate potential applied between the photo-imaging cylinder 4 and the ITM 8, such that the charged electrophotographic ink composition is attracted to the ITM 8. The image is then dried and fused on the ITM 8 before being transferred to a substrate 10. In some examples, the dried and fused image is transferred from the ITM 8 to the substrate by virtue of an appropriate potential applied between the ITM 8 and the substrate.

In some examples, this drying and fusing is achieved by using elevated temperatures and air flow assisted drying. In some examples, the ITM 8 is heatable.

In some examples, the LEP printer 1 comprises a plurality of BID units and each BID unit 6 comprises a reservoir containing a liquid electrophotographic ink composition. In some examples, each of the plurality of BID units 6 contains a different coloured liquid electrophotographic ink composition. In such examples, a multi-coloured image may be provided on a substrate 10.

A multi-coloured image disposed on the substrate may be obtained in one pass of the substrate 10 through the LEP printer 1 or in multiple passes of the substrate 10 through the LEP printer 1.

In examples in which the multi-coloured image disposed on the substrate 10 is obtained in one pass of the substrate 10 through the LEP printer 1, after forming the latent electrostatic image on the surface of the photo-imaging cylinder 4, a first coloured electrophotographic ink composition is transferred from one of the plurality of BID units 6 to the photo-imaging cylinder 4 by electrical forces to form a first coloured electrophotographic ink image on the photo-imaging cylinder 4. In this one pass method, the liquid electrophotographic ink image is then transferred from the photo-imaging cylinder 4 to the ITM 8. A second latent electrostatic image is then formed on the surface of the photo-imaging cylinder 4 and a second coloured electrophotographic ink image is then formed on the surface of the photo-imaging cylinder 4. The second coloured electrophotographic ink image is then transferred from the surface of the photo-imaging cylinder 4 to the ITM 8 to form a second coloured electrophotographic ink image disposed on the first coloured electrophotographic ink image on the ITM 8. Subsequent coloured electrophotographic ink images may then be formed on top of the first and second coloured electrophotographic ink images disposed on the ITM 8 before transfer of the coloured electrophotographic ink images from the ITM 8 to the substrate 10.

In examples in which a multi-coloured image disposed on the substrate 10 is obtained in multiple passes of the substrate 10 through the LEP printer 1, different coloured electrophotographic ink images are formed on the photo-imaging cylinder 4 as described above for the single-pass method. However, in the multi-pass method, each different coloured electrophotographic ink image is transferred from the photo-imaging cylinder 4 to the ITM 8 and then from the ITM 8 to the substrate 10 before the next coloured electrophotographic ink image is formed on the photo-imaging cylinder 4 and transferred to the substrate 10 from the photo-imaging cylinder 4 via the ITM 8. The substrate 10 undergoes additional passes through the LEP printer for each additional coloured electrophotographic ink image applied to the substrate 10.

In some examples, the LEP printer comprises a Raster Image Processor (RIP). In some examples, the RIP is configured to communicate with the laser imaging portion 3 and/or the BID units 6 to define which coloured electrophotographic ink composition available for printing should be sent to which location on the photo-imaging cylinder 4 in order to produce a pre-determined multi-coloured image on the substrate 10.

### EXAMPLES

The following illustrates examples of the methods and other aspects described herein. Thus, these Examples should not be considered as limitations of the present disclosure, but are merely in place to teach how to make examples of the present disclosure.

### Materials

### Resin

Nucrel® 699: a copolymer of ethylene and methacrylic acid, made with nominally 11 wt. % methacrylic acid (available form DuPont).

AC-5120: a copolymer of ethylene and acrylic acid with an acrylic acid content of 15 wt. % (available from Honeywell).

### Carrier Liquid

Isobar L™: an isoparaffinic oil comprising a mixture of C11-C13 isoalkanes (produced by Exxon Mobil™; CAS number 64742-48-9.

### Pigment

R900 TiO₂: a white pigment (available from DuPont)

### Charge ADJUVANT

VCA: a mixture of aluminium mono-, di- and tri-stearates (linear C18 carboxylate), that is, a mixture of [Al(OH)₂(C₁₈H₃₅O₂)], [Al(OH)(C₁₈H₃₅O₂)₂] and [Al(C₁₈H₃₅O₂)₃] (available from Fishcher Scientific).

Manolox 240 (M24): a tri-oxy-aluminium tri-octoate (available from Fedchem), which is [Al(C₈H₁₅O₂)₃] in which the C8 carboxylate is a branched chain carboxylate, in heavy oil (62 wt. % solids).

Manolox 360: an aluminium di(isoporpoxide) acetoacetic ester chelate (100 wt. % solids; available from Fedchem).

Manalox 37: an aluminium di(isoporpoxide) acetoacetic ester chelate (80 to 85 wt. % solids in mineral oil; available from Fedchem).

### Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™.

### LEP Ink Composition Preparation Processes

The LEP ink preparation was performed on the laboratory scale. The operational parameters (process time, temperature, mixing rate, high shear mixer rate) were optimized in advance. Scaling up the process to the plant scale, results in the following changes:

3 h to 4 h grinding on the laboratory scale is equivalent to 30 h grinding on the plant scale (in a Buhler grinding machine).

1 h grinding on the laboratory scale is equivalent to 15 h grinding on the plant scale.

### Reference—Formulation No. 1—Standard White Ink

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration during precipitation: 56 wt. % in mineral oil (Isopar L).

### Stage 1: Precipitation Process

2.62 Kg of mineral oil, 0.805 Kg of Nucrel 699 and 0.203 Kg of A-C 5120 were added to a Bachiler reactor (7 L volume) at RT.
The resin and mineral oil mixture was heated to 135° C. for 70 min at 200 rpm.
The mixture was gradually cooled to 125° C. over 20 min.
The pigment (2.38 Kg) was added gradually at rate of 40 g/min, while staying in a temperature range of 100° C. to 120° C. At this stage the rotor stator was operated at 2000 rpm, in addition to the regular mixing.
The mixture was then cooled to 83° C. at a rate of 12° C./h at 200 rpm. At this stage the rotor stator was operated at 2000 rpm, in addition to the regular mixing.
The mixture was then cooled to 70° C. at a rate of 1.5° C./h at 120 rpm.
The mixture was then cooled to 43° C. at 150 rpm.
Isopar L (1.05 Kg) was added to the reactor and the mixture is diluted to 48 wt. % solids while mixing at 150 rpm. The rotor stator was operated at 500 rpm.
Additional Isopar L (0.47 Kg) was added to the reactor and the mixture is diluted to 45 wt. % solids while mixing at 150 rpm. The rotor stator was operated at 500 rpm.
Additional Isopar L (0.54 Kg) was added to the reactor and the mixture is diluted to 42 wt. % solids while mixing at 150 rpm. The rotor stator was operated at 1000 rpm.

### Stage 2: Grinding Process

5 Kg of precipitated ink from stage 1 (at 42 wt. % solids) was added to a Buhler K8 grinder at constant mixing rate (25 Hz).
VCA (17 g; equal to 0.8 wt. % VCA of total NVS) was added to the mixture.
The mixture was ground at 100% pump flow and 1000 rpm grinding speed. At this stage the maximum temperature can reach 53° C. The chiller infrastructure is then operated to control temperature increase.
The total grinding time is 3 h.

Prior to printing, the LEP ink composition is diluted to 2 to 3 wt. % NVS with Isopar L and a charge director (NCD) is added in an amount of 2.45 mg active NCD/g solids.

### Reference—Formulation No. 2—a Combination of High VCA Amount (5 wt. %) and Shorter Grinding Time (1 h Instead of 3 h)

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration during precipitation: 56 wt. % in mineral oil (Isopar L).

### Stage 1: Precipitation Process

Stage 1 was performed in the same way as for formulation 1.

### Stage 2: Grinding Process

Stage 2 was performed in the same way as for formulation 1 except that 105 g (equal to 5 wt. % of total NVS) of VCA was added and grinding was performed for 1 h.

Prior to printing, the LEP ink composition is diluted to 2 to 3 wt. % NVS with Isopar L and a charge director (NCD) is added in an amount of 2.45 mg active NCD/g solids.

### Reference—Formulation No. 3—a Combination of High VCA Amount (3 wt. %) and Shorter Grinding Time (1 h Instead of 3 h)

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration during precipitation: 56 wt. % in mineral oil (Isopar L).

### Stage 1: Precipitation Process

Stage 1 was performed in the same way as for formulation 1.

### Stage 2: Grinding Process

Stage 2 was performed in the same way as for formulation 1 except that 63 g (equal to 3 wt. % of total NVS) VCA was added to the mixture and grinding was performed for 1 h.

Prior to printing, the LEP ink composition is diluted to 2 to 3 wt. % NVS with Isopar L and a charge director (NCD) is added in an amount of 2.45 mg active NCD/g solids.

### Reference—Formulation No. 4—Standard Amount of VCA (0.8 wt. %) and Shorter Grinding Time (1 h Instead of 3 h)

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration during precipitation: 56 wt. % in mineral oil (Isopar L).

### Stage 1: Precipitation Process

Stage 1 was performed in the same way as for formulation 1.

### Stage 2: Grinding Process

Stage 2 was performed in the same way as for formulation 1 except that 17 g (equal to 0.8 wt % of total NVS) VCA was added to the mixture and grinding was performed for 1 h.

Prior to printing, the LEP ink composition is diluted to 2 to 3 wt. % NVS with Isopar L and a charge director (NCD) is added in an amount of 2.45 mg active NCD/g solids.

Voltage Scan Test (6x00)

The voltage scan experimental technique is based on Developer/Electrode voltage variation with a certain resolution and enables the measurement of OD/Background vs. Developer/Electrode voltage dependence, so that a working window of the Developer/Electrode voltage can be defined. On 400 V developer, the electrode voltage is scanned across the range of 700 V to 1400 V (each point in the graph is +100 V).

The background optical density of a transparent substrate (BOPP/PET 12 μm) is subtracted from the results while measuring the optical density of the explored working dispersion.

The linear correlation between (linear) correlation between optical density and opacity is measured separately and the dependence of Background vs Opacity is determined. The upper limit for background level is considered to be 0.1 for 2 hits.

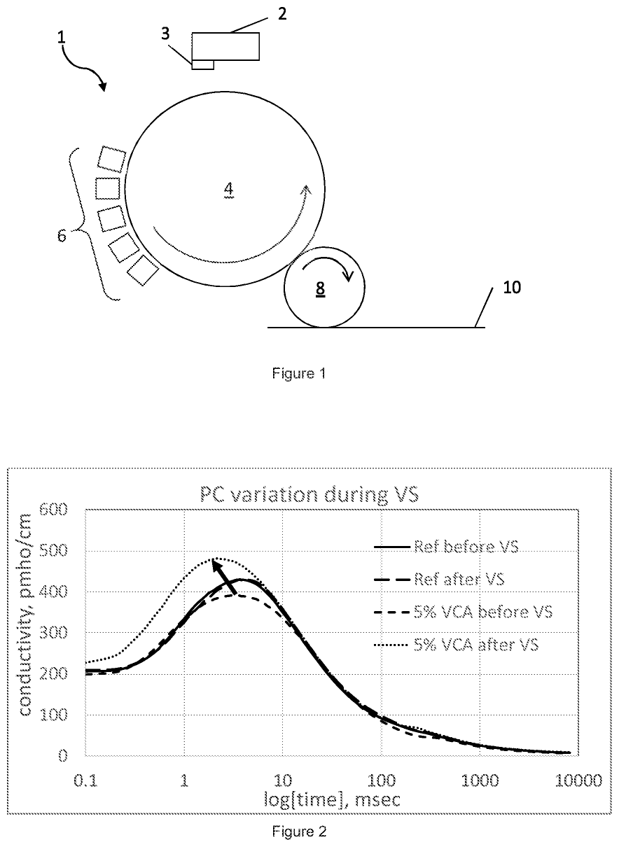

As shown in FIG. 2, the standard white ink (formulation no. 1) shows stable charging when the ink is exposed an external field. The ink charging is monitored by a Q over M machine, before and after aging on the press. The low field (LF), high field (HF) and direct current (DC) values were not influenced by the external field.

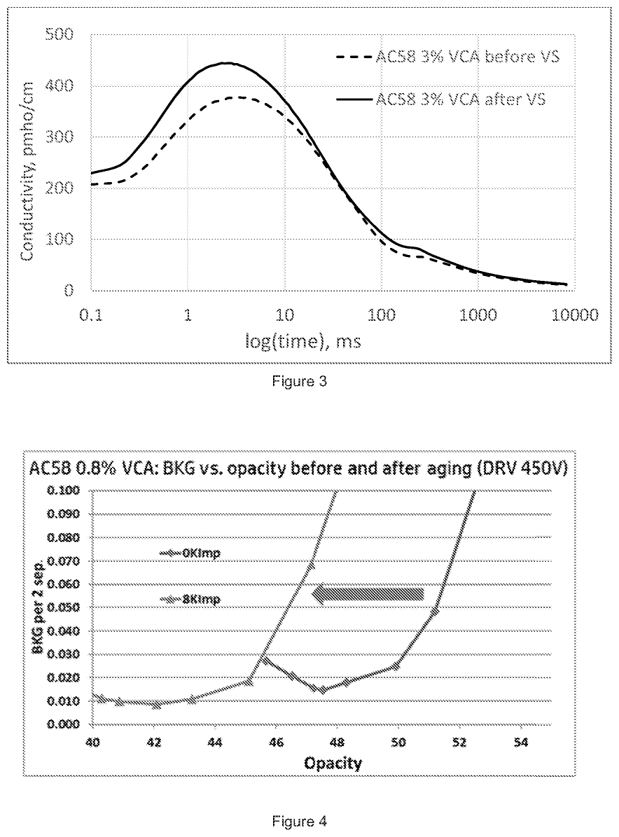

In contrast, LEP ink compositions with a high VCA percentage and shorter grinding time (e.g., formulation numbers 2 and 3, see also FIG. 3) show unstable behavior. The LF, HF and DC changed before and after aging. The LF, HF and DC increased after exposure to the external filed.

FIG. 4 shows that for reference formulation 4, the opacity of the printed ink (in both background (BKG) and image areas) is reduced after the ink is exposed to an external field (i.e., after 8000 impressions (8 Kimp)) due to the unstable particle conductivity (PC).

### Aging Test

The LEP ink composition is aged by cycling the ink over the binary ink developer (BID), exposing it to a high voltage for between several minutes and several hours, without printing any images. Samples of the ink are then taken and the particle conductivity is measured for the samples.

### Results Summary

| Reference | wt. % | Grinding | Charging results from |
|---|---|---|---|
| ink formulation | VCA | time (h) | press tests |
| 1 | 0.8 | 3 | Stable (aging test) |
| 2 | 5 | 1 | Unstable (aging test) |
| 3 | 3 | 1 | Unstable (voltage scan test) |
| 4 | 0.8 | 1 | Unstable (aging test) |

To summarize the results shown in FIGS. 2 to 3: The particle conductivity (PC) of the reference number 1 LEP ink composition is stable before and after aging, while the PC of the reference ink formulations 2 to 4 increases after voltage scan or aging tests. As shown in FIG. 4, the opacity of the printed LEP ink is reduced after aging due to the PC increase. These test results show that the optimum grinding time of LEP ink incorporating 0.8 wt. % VCA is 3 h. When reducing the grinding time to 1 h, the VCA does not fully react with the resins, causing unstable conductivity on the press. As a result, the opacity of the ink reduces during printing, damaging the print quality.

Reducing the amount of VCA to less than 0.8 wt. % might allow shorter grinding times, but for these LEP ink compositions the particle conductivity of the ink is very low. In such a case, to achieve the opacity target, the dry ink mass per area (DMA) would need to increase significantly. This would also influence the cost per page of the ink.

In view of this, a reduction in the grinding time cannot be achieved with VCA without reducing the particle conductivity. Both increasing the amount of VCA and reducing the grinding time resulted in unstable particle conductivity and unacceptable print quality (in particular a reduction in opacity).

### Example Formulations

Several LEP ink compositions were prepared by following the stage 1 process described for formulation 1 but using M24 as the charge adjuvant and altering the stage 2 process as shown in Table 1. The reaction parameters that were altered are temperature when the charge adjuvant is added, mixing time with the charge adjuvant, charge adjuvant concentration before adding the charge adjuvant to the ink and the amount of charge adjuvant in the ink composition.

In small scale tests, M24 was mixed with ink (based on formulation no. 1, after the precipitation stage at 56 wt. % ink solids), according to the parameters in Table 1.

TABLE 1

| | Concentration of M24 | Amount of | | | Yield according |
|---|---|---|---|---|---|
| Test | in a mixture of heavy | M24 in ink | Reaction | Reaction | to GC-MS |
| no. | oil and Isopar L [wt. %] | [wt. % NVS] | T [° C.] | time [h] | analysis [%] |
| 1 | 1.5 | 0.8 | 25 | 3 | 100 |
| 2 | 2.5 | 1.6 | 25 | 3 | 75 |
| 3 | 2.5 | 1.6 | 50 | 3 | 100 |
| 4 | 62 (as supplied) | 1.6 | 25 | 3 | 20 |
| 5 | 2.5 | 0.1 | 40 | 2 | 100 |
| 6 | 2.5 | 0.2 | 40 | 2 | 100 |

### Example Procedure—Test No. 1

The charge adjuvant (M24) was diluted from 62 wt. % solids in heavy oil to 1.5 wt. % solids with Isopar L (10 g of M24 at 62 wt. % NVS was mixed with Isopar L to total mixture amount of 410 g)

The charge adjuvant solution (M24 solution; 30 g at 1.5 wt. % NVS in a mixture of heavy oil and Isopar L; amount calculated to result in an amount of charge adjuvant of 0.8 wt. % based on solids of the ink composition) was mixed with 100 g of LEP ink composition (produced by following the stage 1 process for formulation no. 1 without the dilution stage, i.e., after cooling to 43° C.) at 56 wt. % NVS. The mixture was mixed at RT for 3 h. A sample of the mixture was taken for analytical GC-MS measurement.

### GC-MS Sample Preparation:

A sample of the LEP ink composition (20 g) was centrifuged for 10 min at 7000 rpm. A 3 mL sample from the liquid phase was transferred to a closed vial for GC-MS analysis. The sample preparation was performed immediately after the reaction of M24 with the ink composition.

GC-MS analysis monitored the mass of free octanoic acid ligands (originally from the M24 complex) dissolved in the Isopar L phase, and resulting from the reaction of the acids in the thermoplastic resin with M24 to give a thermoplastic resin-Al complex and dissolved octanoic acid.

The octanoic acid is unstable under GC conditions, resulting in decarboxylation. One way to monitor the presence of octanoic acid is by reacting octanoic acid with N,O-bis(trimethylsilyl)trifluoroacetamide (BSTFA) to give a stable compound (see reaction scheme below).

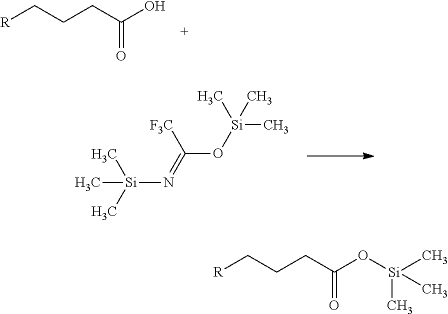

A control experiment was performed to determine whether traces of free octanoic acid were detected in the original M24 solution. M24 dissolved in Isopar L was mixed with BSTFA. The mixture was injected into the GC machine. According to the results, no reaction with BSTFA occurred, meaning that there are no free acid ligands in the commercial M24 material. This test confirms that the only octanoic acids detected in the LEP ink composition by GC, are a by-product from the reaction of M24 with the acid groups of the thermoplastic resin.

### GC-MS Method Used for the Ink Compositions

A 1 ml sample of LEP ink composition was centrifuged at 12,000 rpm for 5 min and 180 μL of the clear supernatant was collected in a glass vial with an insert. Then, 6 μL of the silylating reagent (99 wt. % BSTFA+1 wt. %? chloro(trimethyl)silane (TMCS), Sigma-Aldrich) was added and the mixture was incubated at 60° C. for 4 h in a sealed vial. Gas chromatography-mass spectrometry (GC-MS) analysis was performed on an Agilent 6890/5977A GC-MS (Santa Clara, Calif., USA) system equipped with an Agilent 30 m×0.25 mm i.d. HP-5MS UI column (5 wt. %? phenyl/methylpolysiloxane, 0.25 μm film thickness). The carrier gas was helium (99.999 wt. %) at a constant flow rate of 1.2 mL/min. The GC conditions were as follows: injection volume 0.2 μL (Agilent auto-sampler G4513A, China); injector temperature 250° C. with a split ratio of 1:99; the initial oven temperature was 80° C. and was increased to 140° C. at a rate of 3° C./min, which was followed by raising the temperature to 280° C. at a rate of 30° C./min and a hold of 5 min. MS was performed in the El positive ion mode at a 70 eV electron energy. The transfer line temperature and ion source temperature were maintained at 280° C. and 250° C., respectively.

MS data were collected in the selected-ion monitoring (SIM) mode, maintaining a dwell time of 250 ms for each target ion (m/z 117, 201, 216) and analysed with Chemstation software (Agilent Technologies, Ver. F.01.01.2317).

### Summary GC-MS Results

In view of the GC-MS monitoring of the six test ink compositions (Table 1), the optimized process for incorporating the charge adjuvant M24 into an ink after precipitation are first dissolving the charge adjuvant M24 in Isopar L to a concentration of approximately 2 wt. % and then mixing at a temperature of 40° C. for 2 to 3 h.

Small scale tests numbers 5 and 6 (Table 1) were scaled up as described below (formulations 5 and 6)

### Example—Formulation No. 5—a Combination of 0.1 wt. % M24 and Short a Grinding Time (1 h)

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration after precipitation: 56 wt. % in mineral oil (Isopar L).

### Stage 1: Precipitation Process

2.62 Kg of mineral oil, 0.805 Kg of Nucrel 699 and 0.203 Kg of A-C 5120 were added to a Bachiler reactor (7 L volume) at RT.
The resin and mineral oil mixture was heated to 135° C. for 70 min at 200 rpm. The mixture was gradually cooled to 125° C. over 20 min.
The pigment (2.38 Kg) was added gradually at rate of 40 g/min, while staying in a temperature range of 100° C. to 120° C. At this stage the rotor stator is operated at 2000 rpm, in addition to the regular mixing.
The mixture was then cooled to 83° C. at a rate of 12° C./h at 200 rpm. At this stage the rotor stator was operated at 2000 rpm, in addition to the regular mixing.
The mixture was then cooled to 70° C. at a rate of 1.5° C./h at 120 rpm.
The mixture was then cooled to 43° C. at 150 rpm.
Isopar L (1.05 Kg) was added to the reactor and the mixture is diluted to 48 wt. % solids while mixing at 150 rpm. The rotor stator was operated at 500 rpm.
Charge adjuvant (M24, 113 g of a 3 wt. % solution in Isopar L, i.e., 0.1 wt. % of total solids) was added to the Bachiller in one portion.
Additional Isopar (0.36 Kg) was added to the reactor and the mixture is diluted to 45% solids while mixing at 150 rpm. The rotor stator was operated at 500 rpm
Additional Isopar (0.54 Kg) was added to the reactor and the mixture is diluted to 42% solids while mixing at 150 rpm. The rotor stator was operated at 1000 rpm

### Stage 2: Grinding Process

5 Kg of precipitated ink from stage 1 (at 42 wt. % solids) was added to a Buhler K8 grinder at constant mixing rate (25 Hz).
The mixture was ground at 100% pump flow and 1000 rpm grinding speed. At this stage the maximum temperature can reach 53° C. The chiller infrastructure is then operated to control temperature increase.
The total grinding time is 1 h.

Prior to printing, the LEP ink composition is diluted to 2 to 3 wt. % NVS with Isopar L and a charge director (NCD) is added in an amount of 2.45 mg active NCD/g solids.

### Example—Formulation No. 6—a Combination of 0.2 wt. % M24 and Short Grinding Time 1 h

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration during precipitation: 56 wt. % in mineral oil (Isopar L).

### Stage 1: Precipitation Process

Stage 1 was performed in the same way as for formulation 6 except that 226 g of a 3 wt. % solution of M24 in Isopar L (0.2 wt. % of solids) was added. As a result, only 0.24 kg of Isopar L was required to dilute the composition to 45 wt. % NVS.

### Stage 2: Grinding Process

Stage 2 was performed in the same way as for formulation 5.

Prior to printing, the LEP ink composition is diluted to 2 to 3 wt. % NVS with Isopar L and a charge director (NCD) is added in an amount of 2.45 mg active NCD/g solids.

### Example—Formulation No. 7—a Combination of 0.12 wt. % M24 and No Grinding

### Formulation

30 wt. % resin (a mixture of Nucrel 699 (DuPont): A-C 5120 (Honeywell) in a ratio of 80:20).

70 wt. % pigment (R900 TiO₂ pigment (DuPont)).

Solids concentration 56 wt. % in mineral oil (Isopar L).

### Precipitation Process

8.28 Kg of mineral oil, 2.55 Kg of Nucrel 699 and 0.64 Kg of A-C 5120 were added to a Bachiler reactor (25 L volume) at RT.
The resin and mineral oil mixture was heated to 135° C. for 60 min at 150 rpm.
The mixture was gradually cooled to 125° C. over 20 min at 150 rpm.
The pigment (7.52 Kg) was added gradually at rate of 40 g/min, while staying in a temperature range of 100° C. to 120° C. At this stage the rotor stator is operated at 2000 rpm, in addition to the regular mixing.
The mixture was then cooled to 85° C. in rate of 12° C./h at 150 rpm. At this stage the rotor stator was operated at 2000 rpm, in addition to the regular mixing.
The mixture was then cooled to 70° C. at a rate of 2.0° C./h at 150 rpm.
The mixture was then cooled to 65° C. at 80 rpm.
The mixture was then cooled to 40° C. at 60 rpm.
First dilution: Isopar L (0.4 Kg) was added to the reactor, diluting the mixture to 48 wt. % solids while mixing at 70 rpm. The rotor stator was operated at 600 rpm and the mixture was kept at 40° C.
Second dilution: Isopar L (0.4 Kg) was added to the reactor, diluting the mixture to 48 wt. % solids while mixing at 100 rpm. The rotor stator was operated at 1500 rpm and the mixture was kept at 40° C.
Third dilution: M24 (20.7 g of the 62 wt. % solids solution dissolved in 0.6 Kg of Isopar L; i.e., 0.12 wt. % of total solids) was added to the Bachiller in one portion under mixing at 100 rpm. The rotor stator was operated at 2300 rpm and the mixture was kept at 40° C.
No further processing was used (i.e., no stage 2 process was involved).

Prior to printing, the LEP ink composition is diluted to 2 to 3 wt. % NVS with Isopar L and a charge director (NCD) is added in an amount of 2.45 mg active NCD/g solids.

### Voltage Scan Test Results

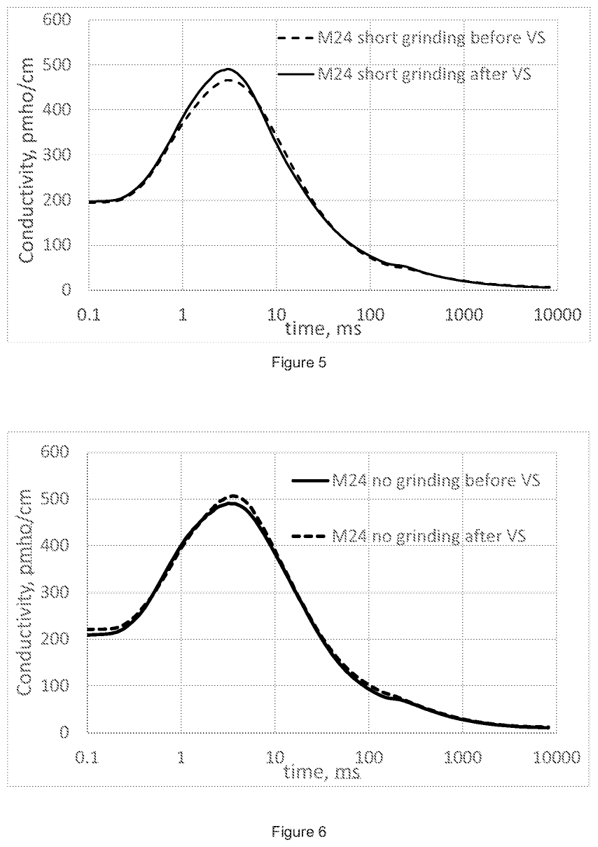

As shown in FIGS. 5 (formulation 6; 0.2 wt. % M24, 1 h grinding) and 6 (formulation 7; 0.12 wt. % M24, no grinding), the particle conductivity of white ink compositions incorporating M24 as the charge adjuvant shows stable charging when the ink is exposed to an external field despite the reduced grinding time (formulation 6) or complete lack of grinding (formulation 7).

### Printing Press Results

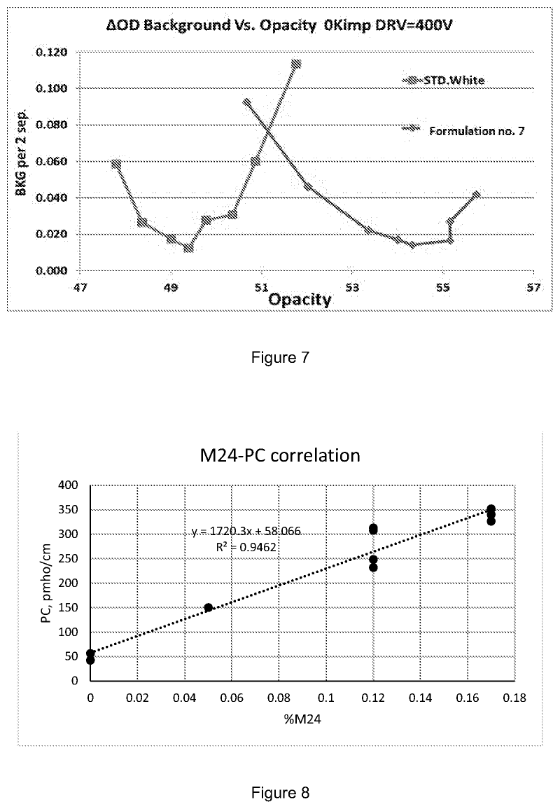

The opacity of an LEP ink composition containing M24 as the charge adjuvant (formulation 7) incorporated after precipitation of the thermoplastic resin in the presence of a white pigment was measured on the printing press. At the same developer voltage (400 V) and electrode voltage scan (700 V) as used for the standard white ink composition (reference formulation 1), the opacity of formulation no. 7 was increased by 4% (see FIG. 7).

### Particle Conductivity

The particle conductivity (PC) of LEP ink formulations with different amounts of charge adjuvant M24 was measured by a Q/M machine. The PC shows a linear increase with amount of M24 (in wt. %; see FIG. 8).

### Summary of Results

M24 is soluble in Isopar L, allowing full ionization of the acid in the thermoplastic resins by mixing under moderate heating, without requiring impact forces (which would be applied by grinding). The M24 was found to be a good charge adjuvant for white LEP ink compositions, allowing high particle conductivity ink to be produced with only a short grinding time or even with no grinding process.

The optimized mixing conditions for M24 as the charge adjuvant in white LEP ink compositions formed by precipitation were found to be diluting M24 (62 wt. % in heavy mineral oil) to 1.5 wt. % to 5 wt. % in Isopar L before adding the diluted charge adjuvant to the ink composition at 56 wt. % to 42 wt. % solids and 40° C. in one portion and mixing for 2-4 hours. According to GC-MS results, the M24 charge adjuvant fully reacted with the acids in the resins (see tests 1, 3, 5 and 6 in Table 1). The complete reaction of M24 was also confirm in by the voltage scan press tests (results shown in FIGS. 5 and 6

Two types of LEP ink composition incorporating M24 as the charge adjuvant were tested. In one a short grinding time was used and in the other no grinding was used. Both ink types show stable conductivity on press and the same behavior as the standard white LEP ink composition. The ink produced without grinding also shows an increase in opacity compared to the standard white LEP ink composition at the same developer and electrode voltage.

### Additional Examples

Liquid electrophotographic ink compositions containing a silver pigment were also prepared by using M24 as the charge adjuvant. These were found to behave similarly to the white formulations. Furthermore, silver ink compositions containing Malanox 37 or Malanox 360 as the charge adjuvant were also prepared. These liquid electrophotographic ink compositions were also found to behave similarly to those containing M24.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. A liquid electrophotographic ink composition comprising:
a thermoplastic resin comprising a polymer having acidic side groups;
a charge adjuvant comprising
a complex of a metal(II) cation and two monovalent anions; or
a complex of a metal(III) cation and three monovalent anions; or
a complex of a metal(III) cation, a divalent anion and a monovalent anion;
wherein each monovalent anion is independently selected from carbon/late anions having from 2 to 16 carbon atoms and alkoxide anions having from 1 to 16 carbon atoms; and
wherein the divalent anion is selected from the oxo group, a dicarboxylate having from 1 to 16 carbon atoms and a dialkoxide having from 1 to 16 carbon atoms; and
a liquid carrier.

2. The liquid electrophotographic ink composition according to claim 1, wherein the complex is a complex of a metal(III) cation and the metal(III) cation is Al³⁺.

3. The liquid electrophotographic ink composition according to claim 1, wherein each monovalent anion is independently selected from octanoate, methylheptanoate, ethylhexanoate, propylpentanoate, propoxide, isopropoxide, acetoacetic methyl ester, acetoacetic ethyl ester, acetoacetic propyl ester, acetoacetic isopropyl ester and combinations thereof; and/or wherein the divalent anion is the oxo group.

4. The liquid electrophotographic ink composition according to claim 1, wherein the charge adjuvant is selected from aluminium trioctanoate, aluminium trimethylheptanoate, aluminium triethylhexanoate, aluminium tripropylpentanoate, aluminium tripropoxide, aluminium triisopropoxide, aluminium di(isopropoxide)-acetoacetic ester chelate.

5. The liquid electrophotographic ink composition according to claim 1, wherein the carrier liquid comprises a hydrocarbon, silicone oil or vegetable oil.

6. The liquid electrophotographic ink composition according to claim 1, wherein the charge adjuvant is present in an amount of up to 2 wt. % of the total solids of the liquid electrophotographic ink composition.

7. The liquid electrophotographic ink composition according to claim 1, further comprising a colorant, wherein the colorant is a white pigment.

8. A method of producing a liquid electrophotographic ink composition comprising:
dissolving a charge adjuvant in a dispersion of a thermoplastic resin in a liquid carrier;
wherein the thermoplastic resin comprises a polymer having acidic side groups; and
wherein the charge adjuvant comprises
a complex of a metal(II) cation and two monovalent anions; or
a complex of a metal(III) cation and monovalent three anions; or
a complex of a metal(III) cation, a monovalent anion and a divalent anion;
wherein each monovalent anion is independently selected from carbon/late anions having from 2 to 16 carbon atoms and alkoxide anions having from 1 to 16 carbon atoms; and
wherein the divalent anion is selected from the oxo group, dicarboxylate anions having from 2 to 16 carbon atoms and alkoxide anions having from 1 to 16 carbon atoms.

9. The method of producing a liquid electrophotographic ink composition according to claim 8, wherein the complex is a complex of a metal(III) cation and the metal(III) cation is Al³⁺.

10. The method of producing a liquid electrophotographic ink composition according to claim 9, wherein dissolving the charge adjuvant in the dispersion does not involve grinding.

11. The method of producing a liquid electrophotographic ink composition according to claim 9, wherein dissolving the charge adjuvant in the dispersion comprises grinding the charge adjuvant in the dispersion for 2 h or less.

12. The method of producing a liquid electrophotographic ink composition according to claim 9, wherein dissolving the charge adjuvant in the dispersion comprises mixing the charge adjuvant with the dispersion.

13. The method of producing a liquid electrophotographic ink composition according to claim 9, wherein dissolving the charge adjuvant in the dispersion comprises mixing the charge adjuvant with the dispersion at a temperature of 60° C. or less.

14. The method of producing a liquid electrophotographic ink composition according to claim 9, wherein the dispersion of a thermoplastic resin in a liquid carrier is formed by precipitating the thermoplastic resin in the carrier liquid.

15. A printed substrate comprising:
a substrate; and
a liquid electrophotographic ink composition disposed on the substrate;
wherein the liquid electrophotographic ink composition comprises:
a thermoplastic resin comprising a polymer having acidic side groups; and
a charge adjuvant comprising
a complex of a metal(II) cation and two monovalent anions; or
a complex of a metal(III) cation and three monovalent anions; or
a complex of a metal(III) cation, a monovalent anion and a divalent anion;
wherein each monovalent anion is independently selected from carbon/late anions having from 2 to 16 carbon atoms and alkoxide anions having from 1 to 16 carbon atoms; and
wherein the divalent anion is selected from the oxo group, dicarboxylate anions having from 2 to 16 carbon atoms and dialkoxide anions having from 1 to 16 carbon atoms.
